(19) United States
(12) Patent Application Publication
(10) Pub. No.: US 2011/0246486 A1
(43) Pub. Date: Oct. 6, 2011

(54) Methods and Systems for Extracting Domain Phrases

(75) Inventors: Ting-Chun Peng, Sindian City (TW); Chia-Chun Shih, Banciao City (TW); Wen-Tai Hsieh, Taipei City (TW)

(73) Assignee: INSTITUTE FOR INFORMATION INDUSTRY, Taipei (TW)

(21) Appl. No.: 12/900,326

(22) Filed: Oct. 7, 2010

(30) Foreign Application Priority Data
Apr. 1, 2010 (TW) 99110086

(51) Int. Cl. G06F 17/30

(52) U.S. Cl. 707/750; 707/E17.044

(57) ABSTRACT

Methods and systems for extracting domain phrases are provided. First, a domain phrase database including a plurality of domain phrases is provided. For a candidate phrase, it is determined whether the candidate phrase is a domain phrase according to an occurrence condition of at least one part of the candidate phrase in the domain phrases of the domain phrase database and the occurrence condition of the at least one part of the candidate phrase at different relative positions in respective domain phrases in respective domain phrases.

### CROSS REFERENCE TO RELATED APPLICATIONS

This Application claims priority of Taiwan Patent Application No. 099110086, filed on Apr. 1, 2010, the entirety of which is incorporated by reference herein.

### BACKGROUND OF THE INVENTION

1. Field of the Invention

The disclosure relates generally to methods and systems for extracting domain phrases, and more particularly, to methods and systems that determine whether a candidate phrase is a domain phrase according to the occurrence condition of at least one part of the candidate phrase in a plurality of domain phrases of a specific domain and the occurrence condition of the at least one part of the candidate phrase at different relative positions in respective domain phrases, to automatically extract the domain phrase.

2. Description of the Related Art

With the development of the Internet, everyone can publish their comments regarding stores or products to blogs, discussion areas, or on-line platforms which allow users to freely publish comments. The comments can collectively reflect the opinions of users, or so-called “word-of-mouth”. Currently, the word-of-mouth information may deeply influence consumers' purchase decisions. Power Research surveyed 1,200 online consumers in 2008, and demonstrated that over 80% of online consumers tend to refer to the comments shared by other online users, and accordingly select one among two or three products. Numerous popular websites are striving to collect customer comments in various specific domains, such as delicacy, network purchasing, and automobile and related accessory, to present the comments to consumers for reference. It's proved that the word-of-mouth information is important for online purchasing.

Additionally, in some websites specially extracted for specific domains, commodity purchasing websites for specific domains, special electronic dictionaries established for specific domains, or knowledge websites for specific domains, a large amount of domain phrases and domain new terms are often collected and updated for the specific domains in order to extract, update or correct related contents of the specific domains.

Currently, the proofreading of phrases and the extraction of new terms of specific domains are mostly performed manually. For example, personnel must first collect related data and personally review or read the data, and extract the domain phrases mentioned in the data. The manual extraction of domain phrases is very time-consuming and laborious, and therefore, the speed of domain phrase collection and extraction is slow, wherein the amount of the domain phrases cannot be quickly increased. Further, due to manual extraction of domain phrases, despite having procedures in place, domain phrases and new terms for specific domains may be subjectively influenced by different personnel. Meanwhile, on the Internet, many new terms are being constantly created and generated. Therefore, some mechanisms have been developed to automatically search for new terms, such as Taiwan Patent No. 490654, named “method and system of automatically extracting new words”.

However, the current mechanisms of automatically searching phrases/new terms usually simply make determinations based on statistical methods. For example, language texts are first divided into strings, and the number of times of respective string occurred in a language corpus or in the results searched from Internet is calculated, and then noisy terms, such as unnecessary or unimportant terms are filtered out from the strings and phrases are outputted. The outputted phrases can be further filtered according to existing phrases to obtain new terms. However, the accuracy of the outputted phrases and new terms is low. For example, in the current technology, during seeking of phrases/new terms for the domain of “delicacy”, there is no way to determine whether the found phrases/new terms belong to the domain of “delicacy” or not. Therefore, it is usually to classify related documents at first, or a corpus of the “delicacy” domain must be established in advance for assisting the determination. Since a corpus of a large amount of language content must be used as training sources, the method to determine the document domain of the new terms is time-consuming and laborious. Meanwhile, the searched phrases/new terms may be a phrase, such as “very good” or “fifty dollars”, which may have a high occurrence frequency, but not be the phrase of “delicacy” domain. Therefore, prior art lacks the means to determine/recognize whether searched phrases/new terms belong to a specific domain. Thus, the object for efficient and automatic extraction of domain phrases can not be achieved. It is noted that, some determination mechanisms for specific domains can be performed by implementing document classification or establishment of language corpora for respective domains. However, a corpus of a large amount of content must be used as training sources; it wastes time and labor power to determine an document domain of domain new terms.

### BRIEF SUMMARY OF THE INVENTION

Methods and systems for extracting domain phrases are provided.

In an embodiment of a method for extracting domain phrases, a domain phrase database comprising a plurality of domain phrases is provided. A candidate phrase is received, and a representative score corresponding to the candidate phrase is determined according to the occurrence condition of at least one part of the candidate phrase in the domain phrases of the domain phrase database and the occurrence condition of the at least one part of the candidate phrase at different relative positions in respective domain phrases. It is determined whether the representative score corresponding to the candidate phrase is greater than a predefined representative threshold. When the representative score corresponding to the candidate phrase is greater than the predefined representative threshold, it is determined that the candidate phrase is a domain phrase.

An embodiment of a system for extracting domain phrases at least includes a storage unit and a processing unit linked to the storage unit. The storage unit comprises a domain phrase database comprising a plurality of domain phrases. The processing unit receives a candidate phrase, and determines a representative score corresponding to the candidate phrase according to the occurrence condition of at least one part of the candidate phrase in the domain phrases of the domain phrase database and the occurrence condition of the at least one part of the candidate phrase at different relative positions in respective domain phrases. The processing unit determines whether the representative score corresponding to the candidate phrase is greater than a predefined representative threshold. When the representative score corresponding to the candidate phrase is greater than the predefined representative threshold, the processing unit determines that the candidate phrase is a domain phrase.

In another embodiment of a method for extracting domain phrases, a domain phrase database comprising a plurality of domain phrases is provided, and a domain featured term database comprising a plurality of domain featured terms is provided, wherein each domain featured term is extracted from the domain phrases, and the domain featured term database further records the occurrence condition of each domain featured term at different relative positions in respective domain phrases. A candidate phrase is received, and based on the candidate phrase and the domain featured term database, at least one specific domain featured term corresponding to the candidate phrase is found, and the occurrence condition of the at least one specific domain featured term at different relative positions in respective domain phrases is retrieved. Then, a representative score corresponding to the candidate phrase is determined according to the occurrence condition of the at least one specific domain featured term at different relative positions in respective domain phrases. It is determined whether the representative score corresponding to the candidate phrase is greater than a predefined representative threshold. When the representative score corresponding to the candidate phrase is greater than the predefined representative threshold, it is determined that the candidate phrase is a domain phrase.

An embodiment of a system for extracting domain phrases at least includes a storage unit and a processing unit linked to the storage unit. The storage unit comprises a domain phrase database comprising a plurality of domain phrases, and a domain featured term database comprising a plurality of domain featured terms, wherein each domain featured term is extracted from the domain phrases, and the domain featured term database further records the occurrence condition of each domain featured term at different relative positions in respective domain phrases. The processing unit receives a candidate phrase, based on the candidate phrase and the domain featured term database, finds at least one specific domain featured term corresponding to the candidate phrase, and retrieves the occurrence condition of the at least one specific domain featured term at different relative positions in respective domain phrases. The processing unit determines a representative score corresponding to the candidate phrase according to the occurrence condition of the at least one specific domain featured term at different relative positions in respective domain phrases, and determines whether the representative score corresponding to the candidate phrase is greater than a predefined representative threshold. When the representative score corresponding to the candidate phrase is greater than the predefined representative threshold, the processing unit determines that the candidate phrase is a domain phrase.

In some embodiments, the candidate phrase may include a plurality of words, wherein one of the plurality of words and any combination of at least two connected words among the words are selected as at least one featured element. The occurrence condition of at least one part of the candidate phrase in the domain phrases of the domain phrase database is determined according to the occurrence frequency of each of the at least one featured element in the domain phrases of the domain phrase database. In other embodiments, the occurrence condition of the at least one part of the candidate phrase at different relative positions in respective domain phrases is determined according to the occurrence frequency of each of the at least one featured element at different relative positions in respective domain phrases.

In some embodiments, the candidate phrase may include a plurality of words, wherein any word or a combination of at least two connected words among the words becomes at least one featured element. The occurrence condition of the at least one part of the candidate phrase at different relative positions in respective domain phrases can be determined according to the occurrence frequency of each featured element at different relative positions in respective domain phrases.

Methods for extracting domain phrases may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1A is a schematic diagram illustrating an embodiment of a system for extracting domain phrases of the invention;

FIG. 1B is a schematic diagram illustrating another embodiment of a system for extracting domain phrases of the invention;

FIG. 2 is a flowchart of an embodiment of a method for extracting domain phrases of the invention; and

FIG. 3 is a flowchart of another embodiment of a method for extracting domain phrases of the invention.

### DETAILED DESCRIPTION OF THE INVENTION

Methods and systems for extracting domain phrases are provided.

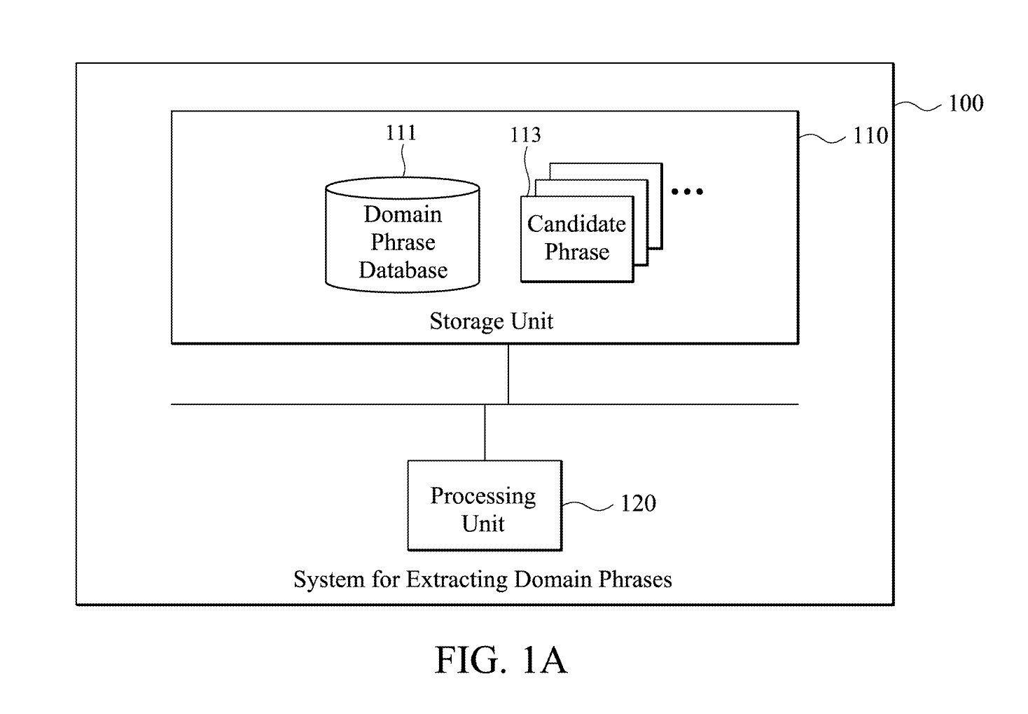

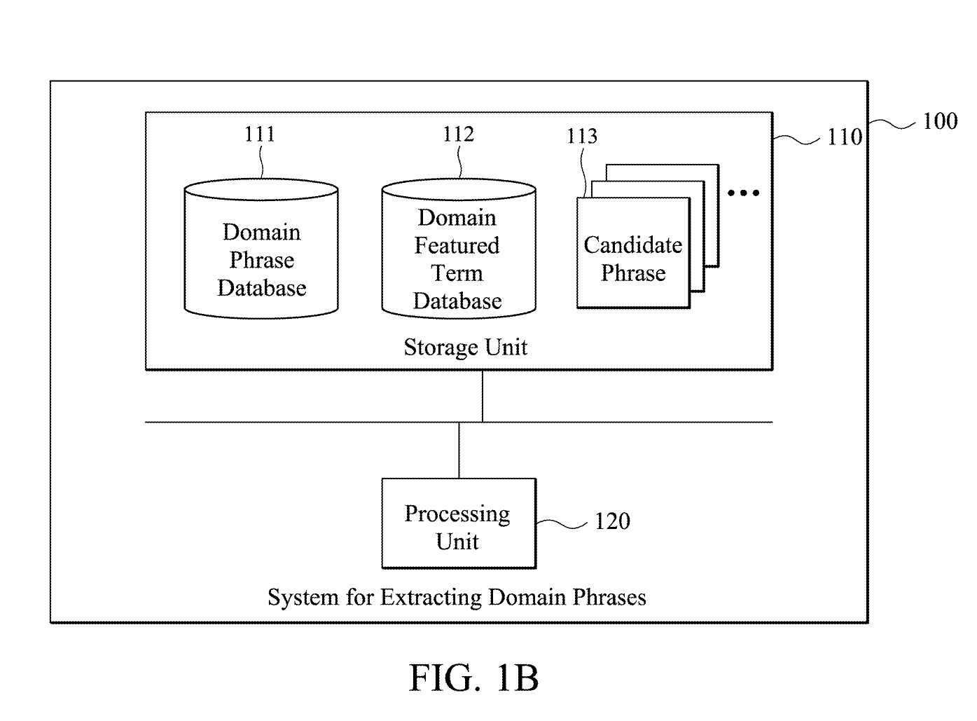

FIG. 1A is a schematic diagram illustrating an embodiment of a system for extracting domain phrases of the invention. The system for extracting domain phrases 100 can be a processor-based electronic device, such as a computer, a server, a notebook, a portable/mobile device, or a workstation.

The system for extracting domain phrases 100 comprises a storage unit 110 and a processing unit 120. The storage unit 110 comprises a domain phrase database 111 including a plurality of domain phrases for a specific domain. The processing unit 120 links to the storage unit 110. The processing unit 120 and the storage unit 110 may be set in the same electronic device, or be set in two electronic devices which are linked with each other via a communication connection, such as an RS232, Intranet, or Internet connection. The candidate phrase 113 is a phrase which waits for the processing unit 120 to determine whether it is a domain phrase of the specific domain. In some embodiments, the candidate phrase 113 can be input and stored in the storage unit 110 in advance. In other embodiments, the system for extracting domain phrases 100 can comprise a receiving unit (not shown), such as wired or wireless communication unit, or a communication interface device to externally receive a plurality of candidate phrases 113. For example, at least a document or data corresponding to the specific domain can be automatically searched for via a network, and the candidate phrases 113 can be obtained from the document or data according to at least one statistical probability model, such as an association rule mining, or TF (Term Frequency)/IDF (Inverse Document Frequency) statistics model. In other embodiments, the system for extracting domain phrases 100 can further comprise an input unit (not shown), such as a keyboard, a mouse, a touch-sensitive screen or an operational interface, for users to manually input the candidate phrases 113. The processing unit 120 is integrated with hardware and software to perform the methods for extracting domain phrases of the invention, which will be discussed further in the following paragraphs.

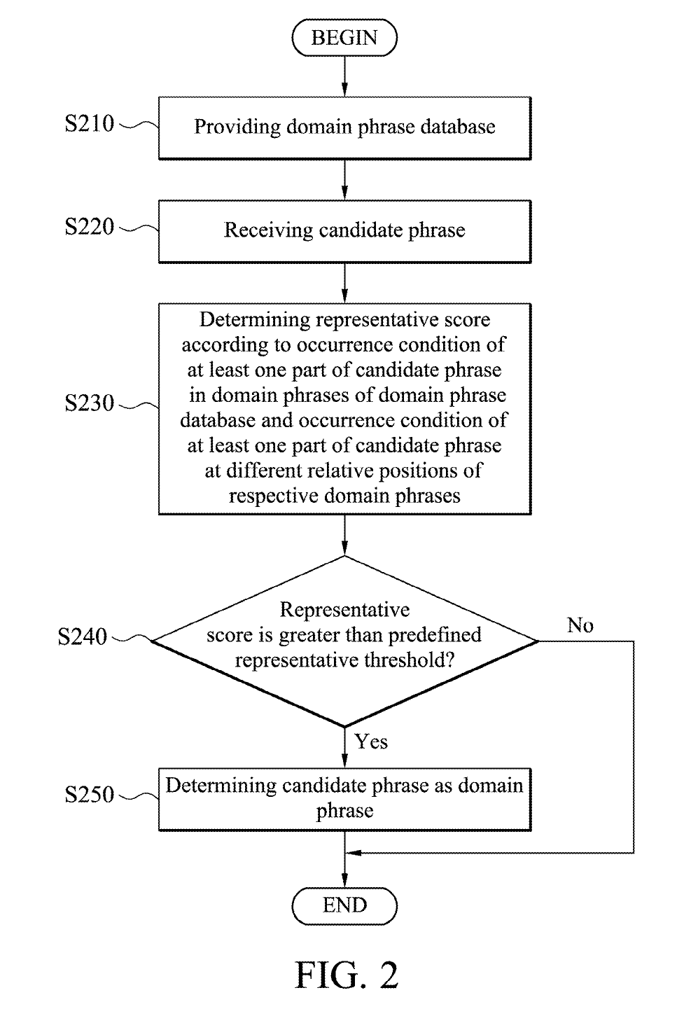

FIG. 2 is a flowchart of an embodiment of a method for extracting domain phrases of the invention.

In step S210, a domain phrase database including a plurality of domain phrases for a specific domain is provided. In this embodiment, the domain phrases are collected and stored for the specific domain in advance. Generally, a lot of domain phrases for the domain phrases in this embodiment are not needed. In some embodiments, the accuracy of the automatic extraction of domain phrases may be good enough when the number of domain phrases is about 100 to 600.

In step S220, a candidate phrase is received. As described, the candidate phrase can be stored in the storage unit in advance, or received via a receiving unit or an input unit.

In step S230, a representative score corresponding to the candidate phrase is determined according to an occurrence condition of at least one part of the candidate phrase in the domain phrases of the domain phrase database and the occurrence condition of the at least one part of the candidate phrase at different relative positions in respective domain phrases.

In some embodiments, the candidate phrase may include a plurality of words, wherein any word or a combination of at least two connected words among the words becomes at least one featured element of the candidate phrase. One candidate phrase may have a plurality of featured elements, and each featured element may be a part of the candidate phrase. It is noted that, overlap may exist between the featured elements. For example, when the candidate phrase is “beef soup noodle”, the featured elements may be “beef”, “beef soup”, “soup noodle”, “soup”, and “noodle”. Therefore, the occurrence condition of at least one part of the candidate phrase in the domain phrases of the domain phrase database described in step S230 can be calculated according to an occurrence frequency of each featured element of the candidate phrase in the domain phrases of the domain phrase database, to generate a corresponding score. For example, the score is higher when the occurrence condition is higher. The score can be called a first featured score. In other embodiments, the occurrence condition of the at least one part of the candidate phrase at different relative positions in respective domain phrases described in step S230 can be determined according to an occurrence condition of each featured element of the candidate phrase at different relative positions, such as a prefix, an midfix, or a suffix of respective domain phrases to generate a corresponding score. For example, when a featured element is located at the prefix of the candidate phrase, and the frequency of the featured element located at the prefix of the respective candidate phrases in the domain phrase database is high, a high value is given as the score. The score can be called a second featured score.

In some embodiments, the representative score corresponding to the candidate phrase can be obtained by adding the first featured score with the second featured score, by using different coefficients to adjust the corresponding weightings or percentages respectively corresponding to the first featured score and the second featured score, or by calculating, according to a formula, the first featured score and the second featured score.

In step S240, it is determined whether the representative score corresponding to the candidate phrase is greater than a predefined representative threshold. In some embodiments, the predefined representative threshold may be an experience value suggested or determined by an expert, determined using a statistics distribution manner, or determined using a specific calculation formula.

In step S250, when the representative score corresponding to the candidate phrase is greater than the predefined representative threshold (Yes in step S240), the candidate phrase is determined to be a domain phrase of the specific domain.

Further, when the representative score corresponding to the candidate phrase is not greater than the predefined representative threshold (No in step S240), it is determined that the candidate phrase is not a domain phrase of the specific domain.

Further, after step S250, the method can further comprises a step S260 (not shown in FIG. 2) to store the candidate phrase which is determined as the domain phrase to the domain phrase database, to update the domain phrase database.

Further, in other embodiments, when a lower representative score means that the candidate phrase has a higher representative (importance), in step S240, it is determined whether the representative score corresponding to the candidate phrase is less than a predefined representative threshold. The predefined representative threshold may be an experience value suggested or determined by an expert, determined using a statistics distribution manner, or determined using a specific calculation formula. Also, in step S250, when the representative score corresponding to the candidate phrase is less than the predefined representative threshold (Yes in step S240), the candidate phrase is determined to be a domain phrase of the specific domain.

FIG. 1B is a schematic diagram illustrating another embodiment of a system for extracting domain phrases of the invention.

The system for extracting domain phrases 100 comprises a storage unit 110 and a processing unit 120. The storage unit 110 comprises a domain phrase database 111 including a plurality of domain phrases for a specific domain, a domain featured term database 112 including a plurality of domain featured terms for the specific domain, and at least one candidate phrase 113. Each domain featured term is extracted from the domain phrases of the domain phrase database 111, and the domain featured term database 112 further records the occurrence condition of each domain featured term at different relative positions in respective domain phrases of the domain phrase database 111. For example, a domain featured term may occur at the prefix, midfix or suffix of respective domain phrases, and a corresponding occurrence condition can be represented by the occurrence frequency of the domain featured term at the prefix, midfix or suffix of respective domain phrases. The generation of the domain featured term will be discussed later. It is understood that, the system 100 can also receive or input the candidate phrase via a receiving unit or an input unit. The processing unit 120 performs the methods for extracting domain phrases of the invention, which will be discussed further in the following paragraphs.

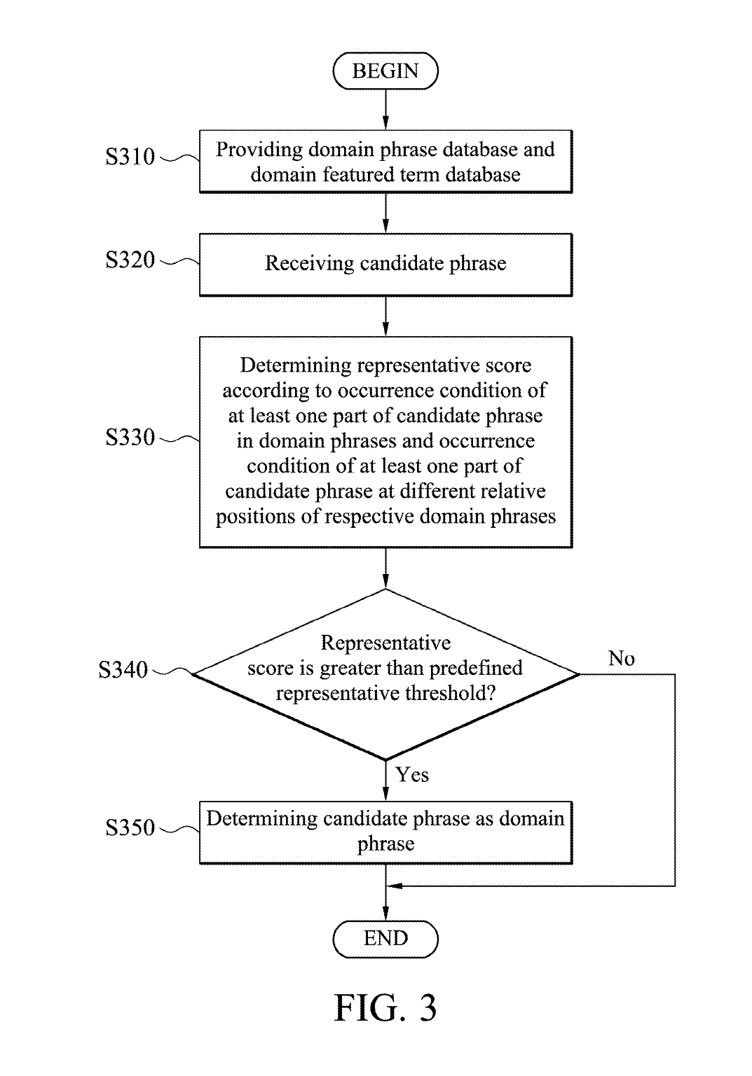

FIG. 3 is a flowchart of another embodiment of a method for extracting domain phrases of the invention.

In step S310, a domain phrase database and a domain featured term database are provided. The descriptions for the domain phrase database and the domain featured term database are similar to the descriptions described above, and related details are omitted herefrom.

Further, there are several ways to extract the domain featured terms from the domain phrases of the domain phrase database. In some embodiments, at least two adjacent words in a specific domain phrase can be first selected as an association term, and an association degree is calculated for the respective association term based on the occurrence frequency of the respective association term in the domain phrases. Then, the association term is extracted as the domain featured term for the specific domain from the specific domain phrase based on whether the association degree corresponding to the association term is greater than a predefined association threshold. In some embodiments, if only one association term is selected from the specific domain phrase, the association term is extracted as the domain featured term for the specific domain when the association degree corresponding to the association term is greater than the predefined association threshold. In some embodiments, if a plurality of association terms is selected from the specific domain phrase, it is respectively determined whether the association degree corresponding to each of the association term is greater than the predefined association threshold. When the association degree corresponding to the respective association term is greater than the predefined association threshold, the respective association term is extracted as the domain featured term for the specific domain. If a single word still exists for the specific domain phrase after the association terms which are extracted as the domain featured term are removed from the specific domain phrase, it is determined whether to extract the single word as the domain featured term for the specific domain according to an occurrence frequency of the single word in the domain phrases. In some further embodiments, if a plurality of association terms is selected from the specific domain phrase, based on the relative high-low relationship of the association degrees corresponding to the association terms, the association term having the higher or highest association degree relative to that of other association terms can be extracted as the domain featured term for the specific domain. Next, if a single word still exists in the specific domain phrase after the association terms which are extracted as the domain featured term are removed from the specific domain phrase, it is determined whether to extract the single word as the domain featured term for the specific domain according to an occurrence frequency of the single word in the domain phrases.

In other embodiments of the extraction manner, any single word and any at least two adjacent words in a specific domain phrase among the domain phrases can be selected to form a domain featured term candidate set. Based on the occurrence frequency of each word (in the domain featured term candidate set) in the domain phrases, it is determined whether the respective occurrence frequency is less than a predefined threshold. When the occurrence frequency is less than the predefined threshold, the corresponding word is removed from the domain featured term candidate set. The word remaining in the domain featured term candidate set is the domain featured term for the specific domain.

Further, the predefined association threshold may be an experience value determined by an expert, determined using a statistics distribution manner, or determined using a specific calculation formula.

In some embodiments, MI (Mutual Information) technology can be used to calculate the association degree between any two adjacent words. The formula of the MI technology follows:

$$MI ( {c}_{a} {c}_{b} ) = {log}_{2} ( \frac{Nfreq ( {c}_{a} {c}_{b} )}{freq ( {c}_{a} ) freq ( {c}_{b} )} ) ,$$

wherein cₐ and c_{b} are two adjacent words, freq(cₐc_{b}) denotes the occurrence frequency of the adjacent words cₐ and c_{b} in the domain phrases of the domain phrase database, freq(cₐ) is the occurrence frequency of the words cₐ in the domain phrases of the domain phrase database, freq(c_{b}) is the occurrence frequency of the words c_{b} in the domain phrases of the domain phrase database, N is the number of the domain phrases of the domain phrase database, and MI(cac_{b}) is the association degree between the adjacent words cₐ and c_{b}. The association degree corresponding to the at least two words can be compared with a predefined association threshold. When the association degree corresponding to the at least two words is greater than the predefined association threshold, the at least two words can be determined as the domain featured term for the specific domain.

For example, when a domain phrase is “Stewed Fish Maw with Shredded Chicken”, the adjacent two words may be “Stewed Fish”, “Fish Maw”, “Maw with”, “with Shredded”, and “Shredded Chicken” as the association terms. The association degree corresponding to the respective association terms can be calculated according to the above formula of the MI technology, and the corresponding association degree can be obtained, for example, 0.84, 1.463, 0.0, 0.0, 1.701. If the predefined association threshold is 1.0, the domain featured terms extracted from the domain phrase includes “Shredded Chicken” (1.701) and “Fish Maw” (0.463), and the remaining “Stewed” and “with” can be respectively determined as the domain featured terms based on the corresponding occurrence frequency in the domain phrases of the domain phrase database, or can be directly determined as the domain featured terms. In this case, a common stop word “with” can be removed based on a gathered stop word list, which is very easy to collect in nowadays. In other embodiments, when the association degrees corresponding to “Stewed Fish”, “Fish Maw”, “Maw with”, “with Shredded”, and “Shredded Chicken” are 0.84, 1.463, 0.0, 0.0, 1.701, based on the relative magnitude of the association degrees, “1.701” and “1.463” are determined as being the largest among the association degrees, and the corresponding “Shredded Chicken” and “Fish Maw” can be determined as the domain featured terms. Additionally, when the domain featured term occurs at different relative positions of the domain phrase of the specific domain, the domain featured term may have a corresponding weighting, such as the occurrence frequency of the domain featured term at the respective position of the domain phrase of the specific domain. The domain featured terms extracted from the domain phrase of the specific domain, and the occurrence frequency of the respective domain featured term in the domain phrases of the domain phrase database and the occurrence condition of the respective domain featured term at different relative positions in respective domain phrases, such as the occurrence frequency of the respective domain featured term at the prefix, midfix or suffix in respective domain phrases are respectively stored in the domain featured term database.

In step S320, a candidate phrase is received. Similarly, in some embodiments, the candidate phrase can be obtained from an document according to at least one statistical probability model, which may be prior art models, and omitted herefrom.

In step S330, based on the candidate phrase and the domain featured term database, at least one specific domain featured term corresponding to the candidate phrase is found, and the occurrence condition of the at least one specific domain featured term at different relative positions in respective domain phrases is retrieved. A representative score corresponding to the candidate phrase is calculated according to an occurrence condition of the at least one specific domain featured term at different relative positions in respective domain phrases. It is understood that, as described, the domain featured term database can comprise a plurality of domain featured terms extracted from the domain phrases, and record the occurrence frequency of each domain featured term at different relative positions in respective domain phrases of the domain phrase database, or the occurrence condition, such as occurrence frequency of each domain featured term at different relative positions in respective domain phrases of the domain phrase database. In some embodiments, the candidate phrase can be first compared with the domain featured term database to find at least one specific domain featured term conforming to the candidate phrase, and the occurrence frequency of the specific domain featured term at different relative positions in respective domain phrases of the domain phrase database is extracted, or the occurrence condition, such as occurrence frequency of the specific domain featured term at different relative positions in respective domain phrases of the domain phrase database.

It is understood that, in some embodiments, the representative score may comprise a first featured score and a second featured score. The calculation of the representative score will be discussed later. In some embodiments, the first featured score corresponding to the candidate phrase can be calculated according to an occurrence frequency of the at least one specific domain featured term in the domain phrases.

Additionally, the second featured score corresponding to the candidate phrase can be calculated according to an occurrence condition of the at least one specific domain featured term of the candidate phrase at different relative positions in respective domain phrases corresponding to the specific domain. In some embodiments, the second featured score can be calculated according to an occurrence frequency of the at least one specific domain featured term at different relative positions in respective domain phrases, and the number of the different relative positions in the domain phrase where the at least one specific domain featured term may occur. For example, when the number of the different relative positions in the domain phrase where the at least one specific domain featured term may occur is 3, the different relative positions may be prefixes, midfixes, or suffix of the term.

After the first featured score and the second featured score are obtained, in some embodiments, the representative score can be calculated by adding the first featured score with the second featured score. In other embodiments, the representative score can be calculated by using a specific formula, for example, such as the following formula:

Score(Tⱼ)=α×S₁^{1/k}+(1−α)×S₂,

wherein Score(Tⱼ) is the representative score corresponding to the candidate phrase, S₁ is the first featured score, S₂ is the second featured score, α is a weighting used for adjusting the first featured score and the second featured score, and k is used to reduce the influence of the length of the candidate phrase to the candidate phrase. It is noted that, α can be adjusted according to various applications and requirements.

For example, when the importance of the at least one specific domain featured term of the candidate phrase, and the influences of the at least one specific domain featured term in the prefix and suffix positions of the candidate phrase are simultaneously considered, the representative score corresponding to the candidate phrase can be calculated according to the following formula:

Score(Tⱼ)=α×S₁+(1−α)(S_{2(prefix)}+S_{2(suffix)}), wherein S_{2(prefix)} and S_{2(suffix)} respectively represents the influences of the specific domain featured term in the prefix and suffix positions of the candidate phrase Tⱼ.

It is understood that, the above formulas used for calculating the first featured score, the second featured score, and the representative score are examples of the disclosure, and any formula designed according to an occurrence frequency of the candidate phrase in the domain phrase database and the occurrence condition of the candidate phrase at different relative positions in respective domain phrases can be applied in the invention.

After the representative score corresponding to the candidate phrase is obtained, in step S340, it is determined whether the representative score corresponding to the candidate phrase is greater than a predefined representative threshold. When the representative score corresponding to the candidate phrase is not greater than the predefined representative threshold (No in step S340), the procedure is terminated. When the representative score corresponding to the candidate phrase is greater than the predefined representative threshold (Yes in step S340), in step S350, the candidate phrase is determined to be a new domain phrase of the specific domain, and the new domain phrase is added to the domain phrase database.

An embodiment of a computer program product of the invention can be loaded into an electronic device, and when the computer program product is executed, the electronic device performs a method for extracting domain phrases. The electronic device comprises a domain phrase database including a plurality of domain phrases for a specific domain. The computer program product comprises:

a first program code for obtaining a candidate phrase;

a second program code for calculating a representative score corresponding to the candidate phrase is calculated according to an occurrence condition of at least one part of the candidate phrase in the domain phrases of the domain phrase database and the occurrence condition of the at least one part of the candidate phrase at different relative positions in respective domain phrases;

a third program code for determining whether the representative score corresponding to the candidate phrase is greater than a predefined representative threshold; and

a fourth program code for determining that the candidate phrase is a domain phrase of the specific domain when the representative score corresponding to the candidate phrase is greater than the predefined representative threshold.

Another embodiment of a computer program product of the invention can be loaded into an electronic device, and when the computer program product is executed, the electronic device performs a method for extracting domain phrases. The electronic device comprises a domain phrase database including a plurality of domain phrases for a specific domain, and a domain featured term database including a plurality of domain featured terms for the specific domain, wherein each domain featured term is extracted from the domain phrases, and the domain featured term database further records the occurrence condition of each domain featured term at different relative positions in respective domain phrases. The computer program product comprises:

a first program code for obtaining a candidate phrase;

a second program code for finding at least one specific domain featured term corresponding to the candidate phrase, and retrieving the occurrence condition of the at least one specific domain featured term at different relative positions in respective domain phrases, based on the candidate phrase and the domain featured term database;

a third program code for calculating a representative score corresponding to the candidate phrase according to an occurrence condition of the at least one specific domain featured term at different relative positions in respective domain phrases;

a fourth program code for determining whether the representative score corresponding to the candidate phrase is greater than a predefined representative threshold; and

a fifth program code for determining that the candidate phrase is a domain phrase of the specific domain when the representative score corresponding to the candidate phrase is greater than the predefined representative threshold.

Therefore, the methods and systems for extracting domain phrases can determine whether a candidate phrase is a domain phrase according to an occurrence frequency of the candidate phrase in a specific domain and the occurrence condition of the candidate phrase at different relative positions in respective domain phrases, to reduce the time and manpower required for manual extraction of domain phrases.

Methods for extracting domain phrases, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. When implemented on a general-purpose processor, the program code combines with the processor to provide a unique apparatus that operates analogously to the application of specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A computer-implemented method for extracting domain phrases for use in a computer, wherein the computer is programmed to perform the steps of:
providing a domain phrase database comprising a plurality of domain phrases;
receiving a candidate phrase;
determining a representative score corresponding to the candidate phrase according to the occurrence condition of at least one part of the candidate phrase in the domain phrases of the domain phrase database and the occurrence condition of the at least one part of the candidate phrase at different relative positions in respective domain phrases;
determining whether the representative score corresponding to the candidate phrase is greater than a predefined representative threshold; and
when the representative score corresponding to the candidate phrase is greater than the predefined representative threshold, determining that the candidate phrase is a domain phrase.

2. The method of claim 1, wherein the candidate phrase comprises a plurality of words, wherein any word or a combination of at least two connected words among the words is selected as at least one featured element, and the occurrence condition of the at least one part of the candidate phrase in the domain phrases of the domain phrase database is determined according to the occurrence frequency of each of the at least one featured element in the domain phrases of the domain phrase database.

3. The method of claim 1, wherein the candidate phrase comprises a plurality of words, wherein any word or a combination of at least two connected words among the words is selected as at least one featured element, and the occurrence condition of the at least one part of the candidate phrase at different relative positions in respective domain phrases is determined according to the occurrence frequency of each of the at least one featured element at different relative positions in respective domain phrases.

4. The method of claim 1, wherein the candidate phrase comprises a plurality of words, wherein one of the plurality of words and any combination of at least two connected words among the words are selected as at least one featured element, and the occurrence condition of the at least one part of the candidate phrase in the domain phrase database is determined by determining a first featured score according to the occurrence frequency of each of the at least one featured element in the domain phrases of the domain phrase database, determining a second featured score according to the occurrence condition of each of the at least one featured element at different relative positions in respective domain phrases, and determining the representative score according to the first featured score and the second featured score.

5. The method of claim 1, further comprising:
receiving a document; and
obtaining the candidate phrase from the document according to a statistical probability model.

6. The method of claim 1, wherein the computer is programmed by the computer programs which are stored in a machine-readable storage medium.

7. A computer-implemented method for extracting domain phrases for use in a computer, wherein the computer is programmed to perform the steps of:
providing a domain phrase database comprising a plurality of domain phrases;
providing a domain featured term database comprising a plurality of domain featured terms, wherein each domain featured term is extracted from the domain phrases, and the domain featured term database further records the occurrence condition of each domain featured term at different relative positions in respective domain phrases;
receiving a candidate phrase;
based on the candidate phrase and the domain featured term database, finding at least one specific domain featured term corresponding to the candidate phrase, and retrieving the occurrence condition of the at least one specific domain featured term at different relative positions in respective domain phrases;
determining a representative score corresponding to the candidate phrase according to the occurrence condition of the at least one specific domain featured term at different relative positions in respective domain phrases;
determining whether the representative score corresponding to the candidate phrase is greater than a predefined representative threshold; and
when the representative score corresponding to the candidate phrase is greater than the predefined representative threshold, determining that the candidate phrase is a domain phrase.

8. The method of claim 7, further comprising:
selecting at least two adjacent words in a specific domain phrase among the domain phrases as at least one association term, and calculating an association degree for the association term based on the occurrence frequency of the association term in the domain phrases;
determining whether the association degree corresponding to the association term is greater than a predefined association threshold; and
when the association degree corresponding to the association term is greater than the predefined association threshold, extracting the association term as the domain featured term.

9. The method of claim 7, further comprising:
selecting any single word and any at least two adjacent words in a specific domain phrase among the domain phrases to form a domain featured term candidate set, and based on the occurrence frequency of each in the domain featured term candidate set in the domain phrases, determining whether the respective occurrence frequency of the word is less than a predefined threshold; and
when the occurrence frequency is less than the predefined threshold, removing the corresponding word from the domain featured term candidate set, and extracting the word remaining in the domain featured term candidate set as the domain featured term.

10. The method of claim 7, wherein the occurrence condition of the at least one specific domain featured term at different relative positions in respective domain phrases is determined according to the occurrence frequency of the domain featured term at different relative positions in respective domain phrases.

11. The method of claim 7, wherein the computer is programmed by the computer programs which are stored in a machine-readable storage medium.

12. A system for extracting domain phrases, comprising:
a storage unit comprising a domain phrase database comprising a plurality of domain phrases;
a processing unit linked to the storage unit, receiving a candidate phrase, determining a representative score corresponding to the candidate phrase according to the occurrence condition of at least one part of the candidate phrase in the domain phrases of the domain phrase database and the occurrence condition of the at least one part of the candidate phrase at different relative positions in respective domain phrases, determining whether the representative score corresponding to the candidate phrase is greater than a predefined representative threshold, and when the representative score corresponding to the candidate phrase is greater than the predefined representative threshold, determining that the candidate phrase is a domain phrase.

13. The system of claim 12, wherein the candidate phrase comprises a plurality of words, wherein any word or a combination of at least two connected words among the words is selected as at least one featured element, and the occurrence condition of the at least one part of the candidate phrase in the domain phrases of the domain phrase database is determined according to the occurrence frequency of each of the at least one featured element in the domain phrases of the domain phrase database.

14. The system of claim 12, wherein the candidate phrase comprises a plurality of words, wherein any word or a combination of at least two connected words among the words is selected as at least one featured element, and the occurrence condition of the at least one part of the candidate phrase at different relative positions in respective domain phrases is determined according to the occurrence frequency of each of the at least one featured element at different relative positions in respective domain phrases.

15. The system of claim 12, wherein the candidate phrase comprises a plurality of words, wherein one of the plurality of word and any combination of at least two connected words among the words are selected as at least one featured element, and the occurrence condition of the at least one part of the candidate phrase in the domain phrase database is determined by determining a first featured score according to the occurrence frequency of each of the at least one featured element in the domain phrases of the domain phrase database, determining a second featured score according to the occurrence frequency of each of the at least one featured element at different relative positions in respective domain phrases, and determining the representative score according to the first featured score and the second featured score.

16. A system for extracting domain phrases, comprising:
a storage unit comprising a domain phrase database comprising a plurality of domain phrases, and a domain featured term database comprising a plurality of domain featured terms, wherein each domain featured term is extracted from the domain phrases, and the domain featured term database further records the occurrence condition of each domain featured term at different relative positions in respective domain phrases; and
a processing unit linked to the storage unit, receiving a candidate phrase, based on the candidate phrase and the domain featured term database, finding at least one specific domain featured term corresponding to the candidate phrase, and retrieving the occurrence condition of the at least one specific domain featured term at different relative positions in respective domain phrases, determining a representative score corresponding to the candidate phrase according to the occurrence condition of the at least one specific domain featured term at different relative positions in respective domain phrases, determining whether the representative score corresponding to the candidate phrase is greater than a predefined representative threshold, and when the representative score corresponding to the candidate phrase is greater than the predefined representative threshold, determining that the candidate phrase is a domain phrase.

17. The system of claim 16, wherein the processing unit further selects at least two adjacent words in a specific domain phrase among the domain phrases as at least one association term, calculates an association degree for the association term based on the occurrence frequency of the association term in the domain phrases, determines whether the association degree corresponding to the association term is greater than a predefined association threshold, and when the association degree corresponding to the association term is greater than the predefined association threshold, extracts the association term as the domain featured term.

18. The system of claim 16, wherein the processing unit further selects any single word and any at least two adjacent words in a specific domain phrase among the domain phrases to form a domain featured term candidate set, and based on the occurrence frequency of in the domain featured term candidate set in the domain phrases, determines whether the respective occurrence frequency of the word is less than a predefined threshold, and when the occurrence frequency is less than the predefined threshold, removes the corresponding word from the domain featured term candidate set, and extracting the word remaining in the domain featured term candidate set as the domain featured term.

19. The system of claim 16, wherein the occurrence condition of the at least one specific domain featured term at different relative positions in respective domain phrases is determined according to the occurrence frequency of the domain featured term at different relative positions in respective domain phrases.
